(19) United States
(12) Patent Application Publication
(10) Pub. No.: US 2009/0135614 A1
(43) Pub. Date: May 28, 2009

(54) Fluorescent Stick Holding Seat

(76) Inventor: Liang-Jen CHANG, Dongguan (CN)

Correspondence Address: Dr. BANGER SHIA, 102 Lindencrest Ct., Sugar Land, TX, 77479-5201, US

(21) Appl. No.: 12/251,126

(22) Filed: Oct. 14, 2008

(30) Foreign Application Priority Data
Nov. 26, 2007 (CN) 200720060069.9

(51) Int. Cl. F21V 21/00

(52) U.S. Cl. 362/388

(57) ABSTRACT

A fluorescent stick holding seat includes a sphere having three recesses in the same shape. The recesses are adapted to hold fluorescent sticks securely. The axes of the fluorescent sticks are crisscrossed with each other so that the fluorescent sticks are able to stand at a desired position. This enhances the fun of the fluorescent stick decoration and is not subject to the environment, standing steadily and providing a warning sign outdoors.

### BACKGROUND OF THE INVENTION

1. Field of the Invention

The present invention relates to a fluorescent stick holding structure, and more particularly to a fluorescent stick sphere holding seat.

2. Description of the Prior Art

A fluorescent stick is also named a radiating stick or a luminous stick, which is extensively used for decoration in a performance, a birthday party or an outing so as to provide a romantic and warm atmosphere. Because the standard of living is going up, the fluorescent stick is gradually used for decoration at home, office or outdoors to provide a romantic atmosphere or a warning sign. People usually use a single fluorescent stick or more fluorescent sticks connected together for decoration. This is monotone without fun, unable to stand, and hardly to provide a warning sign.

### SUMMARY OF THE INVENTION

The primary object of the present invention is to provide a fluorescent stick holding seat, which enables the fluorescent sticks to stand steadily for decoration, enhances the fun of the fluorescent stick decoration and provides a warning sign outdoors.

According to the present invention, there is provided a fluorescent stick holding seat, comprising a sphere having three recesses in the same shape, the recesses being adapted to hold fluorescent sticks, the axes of the fluorescent sticks held in the recesses being perpendicular with each other.

Preferably, the recesses are disposed on X axis, Y axis and Z axis of the sphere respectively, the X axis, Y axis and Z axis being radiated from the center of the sphere and perpendicular with each other.

Preferably, each of the recesses has a first holding wall, a second holding wall, and a cavity formed between the first holding wall and the second holding wall, and free ends of the first holding wall and the second holding wall are to form an opening which has a diameter smaller than that of the fluorescent stick so as to hold the fluorescent stick.

The advantage of the present invention is to use the three recesses to hold the fluorescent sticks which are crisscrossed with each other so that the fluorescent sticks are able to stand at a desired position. This enhances the fun of fluorescent stick decoration and is not subject to the environment, standing steadily and providing a warning sign.

### BRIEF DESCRIPTION OF THE DRAWINGS

FIG. 1 is a perspective view of the present invention;

FIG. 2 is a perspective view of the present invention coupled with fluorescent sticks;

FIG. 3 is a front view of FIG. 2;

FIG. 4 is a side view of FIG. 2; and

FIG. 5 is a top view of FIG. 2.

### DETAILED DESCRIPTION OF THE PREFERRED EMBODIMENTS

Embodiments of the present invention will now be described, by way of example only, with reference to the accompanying drawings.

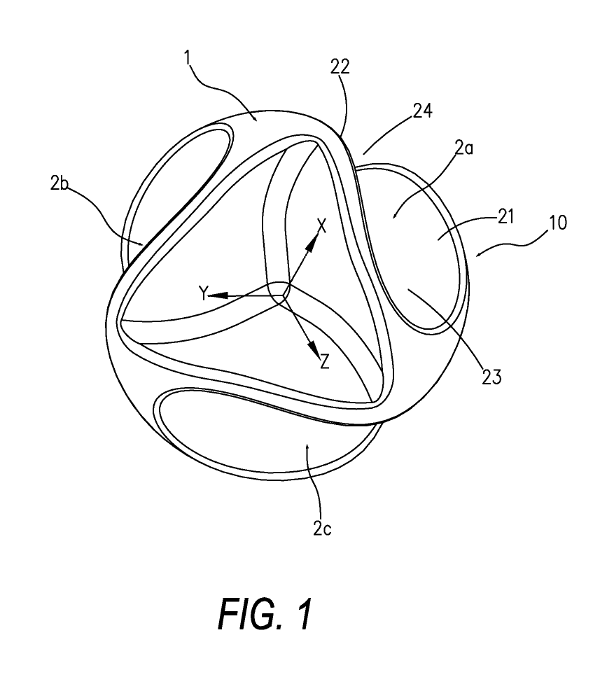

As shown in FIG. 1, a fluorescent stick holding seat 10 according to a preferred embodiment of the present invention includes a sphere 1 having three recesses 2a, 2b and 2c in the same shape. The recesses 2a, 2b and 2c are adapted to hold fluorescent sticks, and disposed on X axis, Y axis and Z axis of the sphere 1 respectively which are radiated from the center of the sphere 1. The fluorescent sticks held in the recesses 2a, 2b, and 2c are perpendicular with each other.

Each of the recesses 2a, 2b, and 2c has a first holding wall 21, a second holding wall 22, and a cavity 23 formed between the first holding wall 21 and the second holding wall 22. Free ends of the first holding wall 21 and the second holding wall 22 are to form an opening 24 which has a diameter smaller than that of the fluorescent stick so as to hold the fluorescent stick securely.

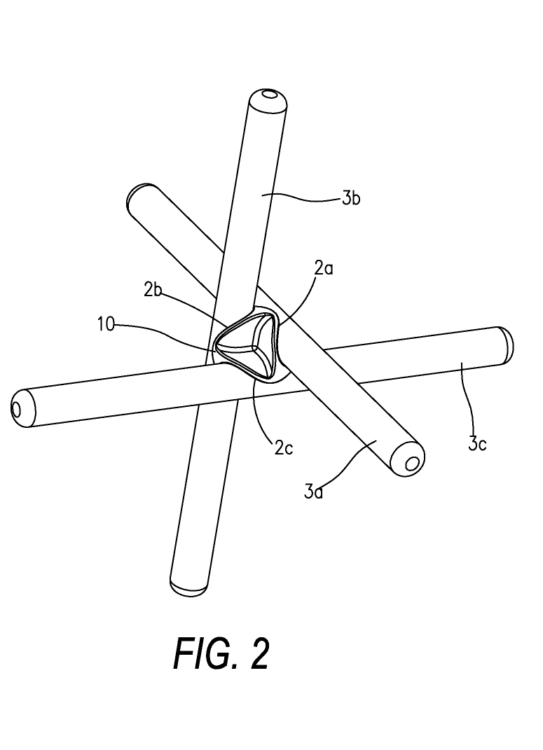

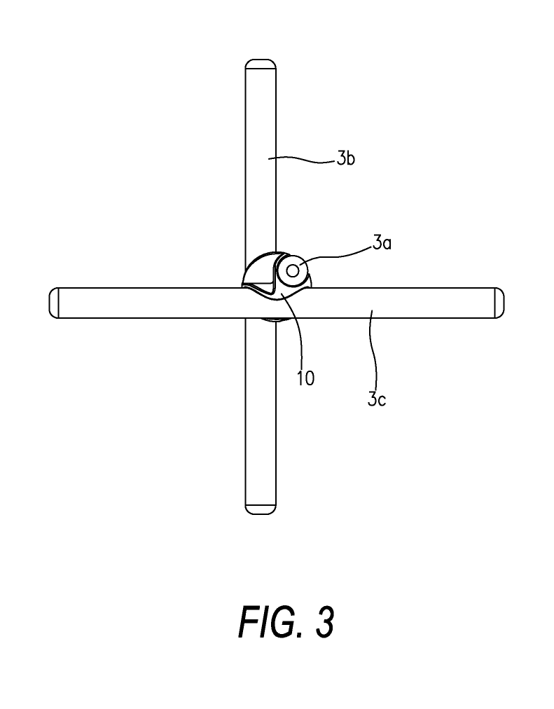

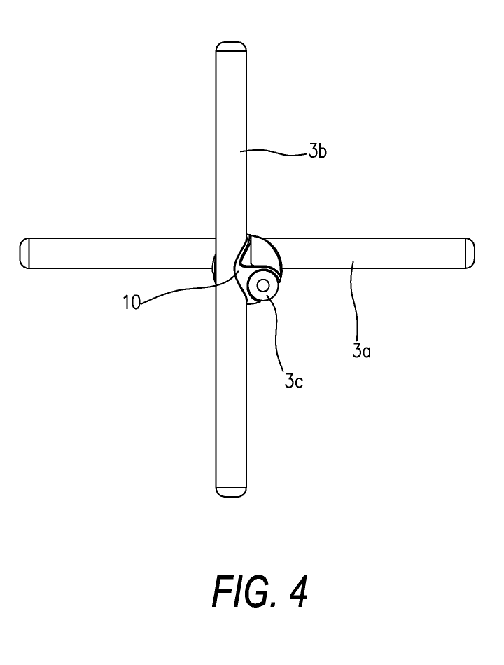

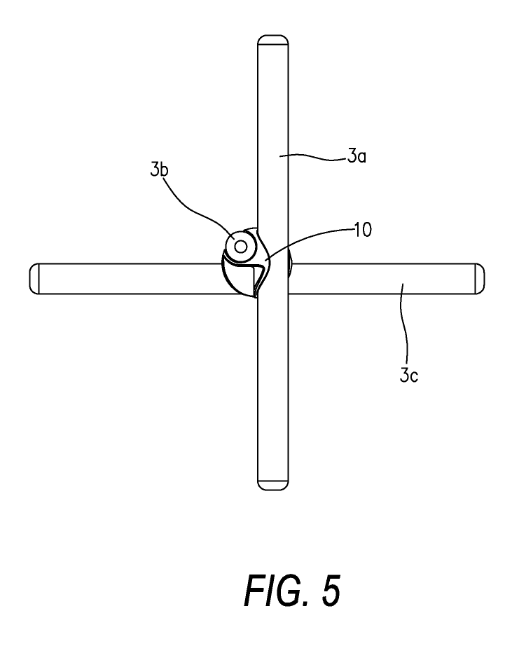

FIG. 2 through FIG. 5 show a respective view, a front view, a side view, and a top view of the present invention coupled with fluorescent sticks 3a, 3b and 3c which have the same length. The fluorescent sticks 3a, 3b and 3c are held in the recesses 2a, 2b and 2c, with their central portions located in the recesses 2a, 2b and 2c. The fluorescent sticks 3a, 3b and 3c are symmetrical after engagement. The axes of the fluorescent sticks 3a, 3b and 3c are crisscrossed with each other so that the fluorescent sticks 3a, 3b and 3c are able to stand at a desired position. This enhances the fun of fluorescent stick decoration and is not subject to the environment, standing steadily and providing a warning sign outdoors.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A fluorescent stick holding seat, comprising a sphere having three recesses in the same shape, the recesses being adapted to hold fluorescent sticks, the axes of the fluorescent sticks held in the recesses being perpendicular with each other.

2. The fluorescent stick holding seat as claimed in claim 1, wherein the recesses are disposed on X axis, Y axis and Z axis of the sphere respectively, the X axis, Y axis and Z axis being radiated from the center of the sphere and perpendicular with each other.

3. The fluorescent stick holding seat as claimed in claim 1, wherein each of the recesses has a first holding wall, a second holding wall, and a cavity formed between the first holding wall and the second holding wall, and free ends of the first holding wall and the second holding wall are to form an opening which has a diameter smaller than that of the fluorescent stick so as to hold the fluorescent stick.
